(19) United States
(12) Patent Application Publication
(10) Pub. No.: US 2004/0091673 A1
(43) Pub. Date: May 13, 2004

(54) Web-shaped structure formed by plastic material

(76) Inventor: Teng-Jen Yang, Taichung Hsien (TW)

Correspondence Address: CHARLES E. BAXLEY, ESQUIRE, Hart, Baxley, Daniels & Holton, 59 John St, 5 Fl, New York, NY, 10038, US

(21) Appl. No.: 10/305,905

(22) Filed: Nov. 27, 2002

(30) Foreign Application Priority Data
Nov. 12, 2002 (TW) 091218091

(51) Int. Cl. B32B 3/28; B32B 3/00; B32B 3/30

(52) U.S. Cl. 428/161; 428/162; 428/163; 428/182; 428/223

(57) ABSTRACT

A web-shaped structure includes a first plastic member provided with a plurality of combination strips, and a second plastic member provided with a plurality of combination strips each combined with each of the combination strips of the first plastic member in a corrugated and intersecting manner, so that the first plastic member and the second plastic member intersect each other and are combined integrally, thereby forming the web-shaped structure which may be used to make a product, such as the cellular phone bag, the hand bag, the basket or the like, so that the product has a corrugated and web-shaped spatial effect, thereby enhancing the aesthetic quality of the product.

### BACKGROUND OF THE INVENTION

1. Field of the Invention

The present invention relates to a web-shaped structure formed by plastic material, and more particularly to a web-shaped structure formed by plastic material, wherein the web-shaped structure may be used to make a product, such as the cellular phone bag, the hand bag, the basket or the like, so that the product has a corrugated and web-shaped spatial effect, thereby enhancing the aesthetic quality of the product.

2. Description of the Related Art

A conventional web-shaped product, such as the hat, the muffler, the vest, the sweater or the like, is formed by hand-knitting or by a weaving machine. However, the figures or patterns are formed on the conventional web-shaped product by printing or by hand drawing. Thus, the figures or patterns formed on the conventional web-shaped product easily become vague, fade or even vanish due to frequent contact with water during a long-term utilization, thereby decreasing the aesthetic quality of the conventional web-shaped product.

### SUMMARY OF THE INVENTION

The present invention has arisen to mitigate and/or obviate the disadvantage of the conventional web-shaped product.

The primary objective of the present invention is to provide a web-shaped structure formed by plastic material, wherein the web-shaped structure may be used to make a product, such as the cellular phone bag, the hand bag, the basket or the like, so that the product has a corrugated and web-shaped spatial effect, thereby enhancing the aesthetic quality of the product.

Another objective of the present invention is to provide a web-shaped structure formed by plastic material, wherein the web-shaped structure is integrally manufactured by a plastic injection molding process, thereby saving the cost of fabrication.

A further objective of the present invention is to provide a web-shaped structure formed by plastic material, wherein the web-shaped structure has an integrally formed figure with variation of the pattern, thereby enhancing the aesthetic quality of the product.

A further objective of the present invention is to provide a web-shaped structure formed by plastic material, wherein the figure of the web-shaped structure will not become vague, fade or vanish due to frequent contact with water during a long-term utilization, thereby enhancing the durability of the product.

A further objective of the present invention is to provide a web-shaped structure formed by plastic material, wherein the elongated rails of the first plastic member and the elongated rails of the second plastic member co-operate to prevent separation of first plastic member from the second plastic member.

A further objective of the present invention is to provide a web-shaped structure formed by plastic material, wherein be design of the elongated rails of the first plastic member and the second plastic member, the product may be sewn or bonded on the shoe vamp or a predetermined position.

A further objective of the present invention is to provide a web-shaped structure formed by plastic material, wherein each of the combination strips of the first plastic member is arranged in an arc-shaped and corrugated manner, and each of the combination strips of the second plastic member is arranged in an arc-shaped and corrugated manner, thereby enhancing the aesthetic quality of the product.

In accordance with the present invention, there is provided a web-shaped structure formed by plastic material, comprising a first plastic member, and a second plastic member combined with the first plastic member integrally, wherein:

the first plastic member is provided with a plurality of combination strips; and

the second plastic member is provided with a plurality of combination strips, each of the combination strips of the second plastic member is mounted on the top end face of one of the combination strips of the first plastic member and is mounted on the bottom end face of the adjacent combination strip of the first plastic member, so that each of the combination strips of the second plastic member is combined with each of the combination strips of the first plastic member in a corrugated and intersecting manner, and the first plastic member and the second plastic member intersect each other and are combined integrally, thereby forming the web-shaped structure.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a web-shaped structure formed by plastic material in accordance with a first embodiment of the present invention;

FIG. 2 is a perspective assembly view of the web-shaped structure formed by plastic material in accordance with the first embodiment of the present invention;

FIG. 3 is a plan cross-sectional view of the web-shaped structure formed by plastic material as shown in FIG. 2;

FIG. 4 is a plan cross-sectional view of the web-shaped structure formed by plastic material as shown in FIG. 2;

FIG. 5 is a plan view of the web-shaped structure formed by plastic material in accordance with the second embodiment of the present invention;

FIG. 6 is a perspective assembly view of the web-shaped structure formed by plastic material in accordance with the third embodiment of the present invention;

FIG. 7 is a plan cross-sectional view of the web-shaped structure formed by plastic material as shown in FIG. 6; and

FIG. 8 is a plan view of the web-shaped structure formed by plastic material in accordance with the fourth embodiment of the present invention;

### DETAILED DESCRIPTION OF THE INVENTION

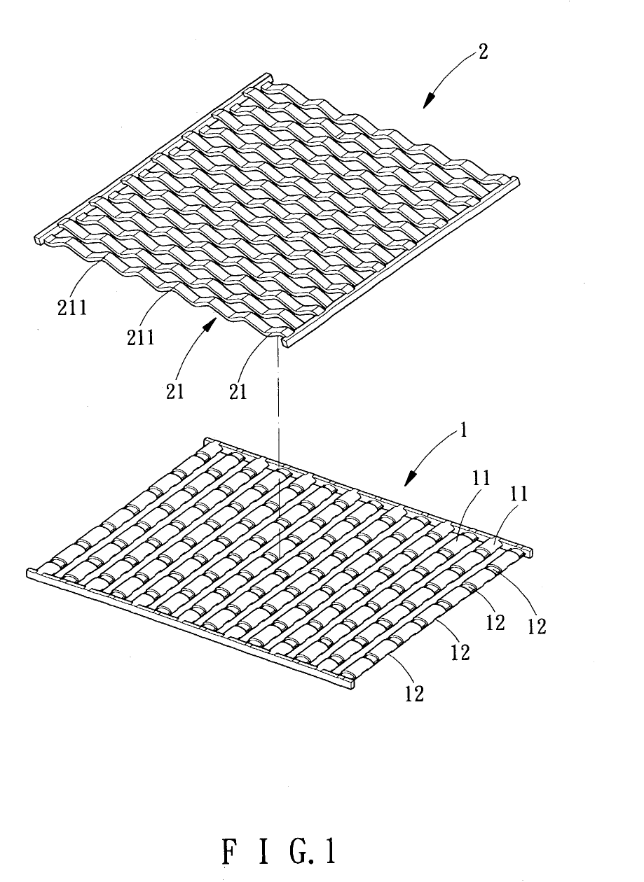

Referring to the drawings and initially to FIGS. 1-4, a web-shaped structure formed by plastic material in accordance with a first embodiment of the present invention comprises a first plastic member 1, and a second plastic member 2 combined with the first plastic member 1 integrally.

The first plastic member 1 is provided with a plurality of combination strips 11 which are arranged in a parallel manner and are spaced apart from each other. Each of the combination strips 11 of the first plastic member 1 has a top end face and a bottom end face each formed with a plurality of recesses 12. The recesses 12 on the top end face and the bottom end face of each of the combination strips 11 of the first plastic member 1 are arranged in a staggered manner as shown in FIG. 4. The recesses 12 on any two adjacent combination strips 11 of the first plastic member 1 are also arranged in a staggered manner as shown in FIG. 1.

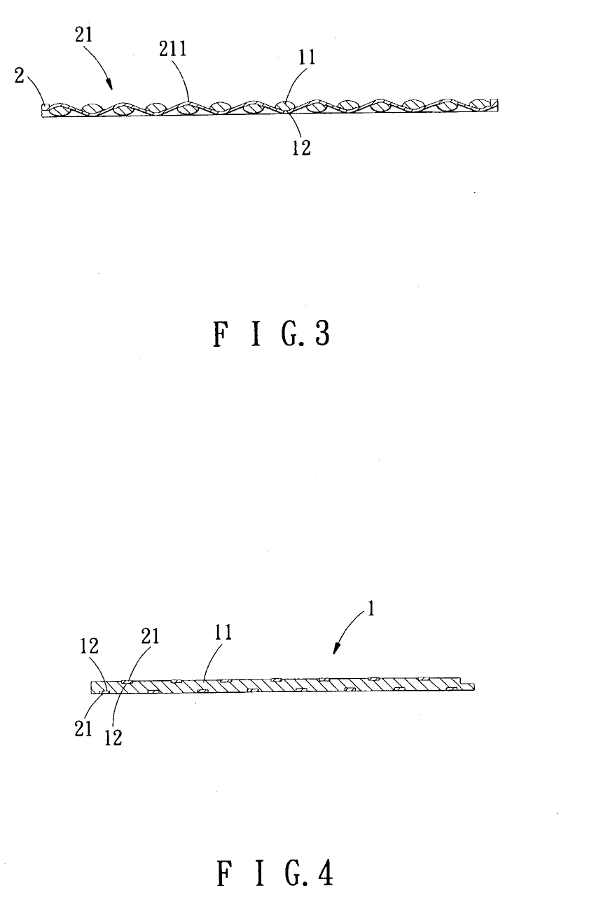

The second plastic member 2 is provided with a plurality of combination strips 21 which are arranged in a parallel manner and are spaced apart from each other. Each of the combination strips 21 of the second plastic member 2 includes a plurality of bent portions 211 connected with each other. The bent portions 211 on any two adjacent combination strips 21 of the second plastic member 2 are arranged in a staggered manner as shown in FIG. 1. Each of the bent portions 211 of the second plastic member 2 is combined with a respective one of the recesses 12 of the first plastic member 1. Preferably, each of the bent portions 211 of the second plastic member 2 is integrally combined with a respective one of the recesses 12 of the first plastic member 1 by a plastic injection molding process. Each of the combination strips 21 of the second plastic member 2 is mounted on the top end face of one of the combination strips 11 of the first plastic member 1 and is mounted on the bottom end face of the adjacent combination strip 11 of the first plastic member 1, so that each of the combination strips 21 of the second plastic member 2 is combined with each of the combination strips 11 of the first plastic member 1 in a corrugated and intersecting manner as shown in FIG. 3.

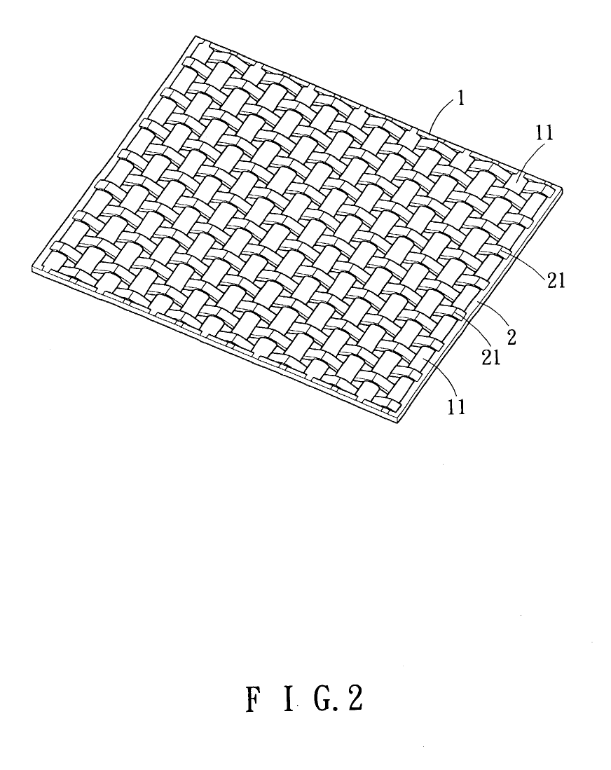

Thus, the first plastic member 1 and the second plastic member 2 intersect each other and are combined integrally, thereby forming the web-shaped structure in accordance with the first embodiment of the present invention as shown in FIG. 2.

Accordingly, the area of the web-shaped structure in accordance with the present invention is not limited, so that the web-shaped structure may be used to make a product, such as the cellular phone bag, the hand bag, the basket or the like, so that the product has a corrugated and web-shaped spatial effect, thereby enhancing the aesthetic quality of the product. In addition, the web-shaped structure in accordance with the present invention is integrally manufactured by a plastic injection molding process, thereby saving the cost of fabrication.

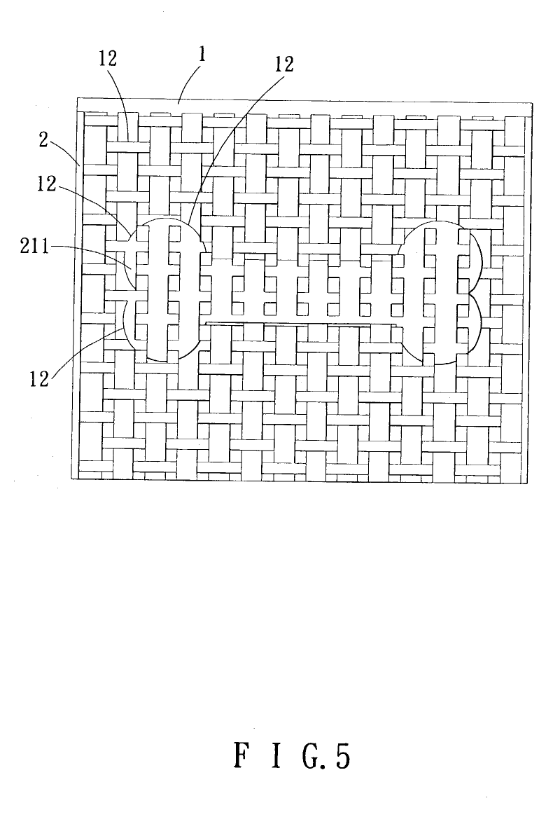

Referring to FIG. 5, the web-shaped structure formed by plastic material in accordance with the second embodiment of the present invention is similar to that in accordance with the first embodiment of the present invention, and the difference is described as follows. The recesses 12 of the first plastic member 1 and the bent portions 211 of the second plastic member 2 are formed with different patterns according to the practical requirements, so that the recesses 12 of the first plastic member 1 are combined with the bent portions 211 of the second plastic member 2 to form a predetermined figure pattern which protrudes outward from the first plastic member 1.

Accordingly, the web-shaped structure has an integrally formed figure with variation of the pattern, thereby enhancing the aesthetic quality of the product. In addition, the figure of the web-shaped structure will not become vague, fade or vanish due to frequent contact with water during a long-term utilization, thereby enhancing the durability of the product.

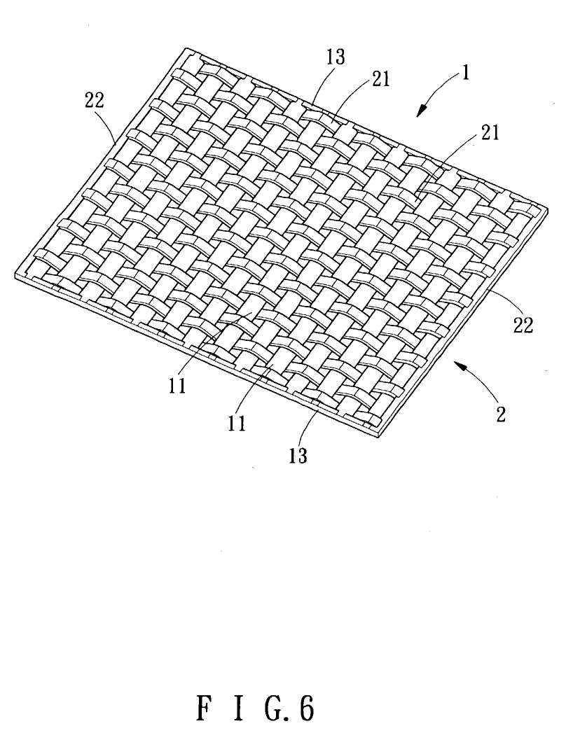

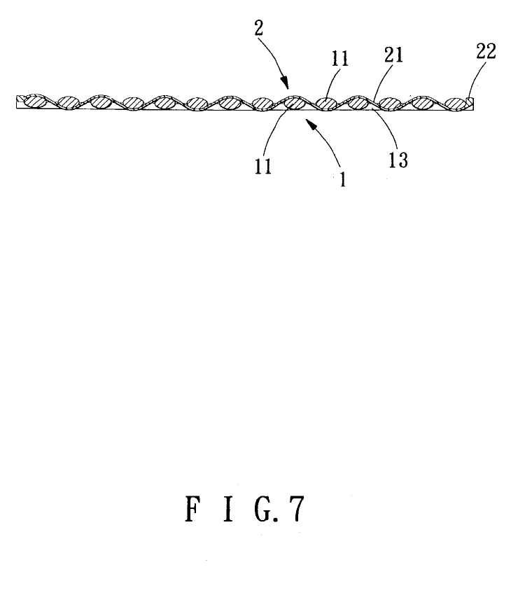

Referring to FIGS. 6 and 7, the web-shaped structure formed by plastic material in accordance with the third embodiment of the present invention is similar to that in accordance with the first embodiment of the present invention, and the difference is described as follows. The first plastic member 1 includes two opposite elongated rails 13 each integrally formed on each end of each of the combination strips 11 of the first plastic member 1. The second plastic member 2 includes two opposite elongated rails 22 each integrally formed on each end of each of the combination strips 21 of the second plastic member 2.

Accordingly, the elongated rails 13 of the first plastic member 1 and the elongated rails 22 of the second plastic member 2 co-operate to prevent separation of first plastic member 1 from the second plastic member 2. In addition, be design of the elongated rails 13 of the first plastic member 1 and the elongated rails 22 of the second plastic member 2, the product may be sewn or bonded on the shoe vamp or a predetermined position.

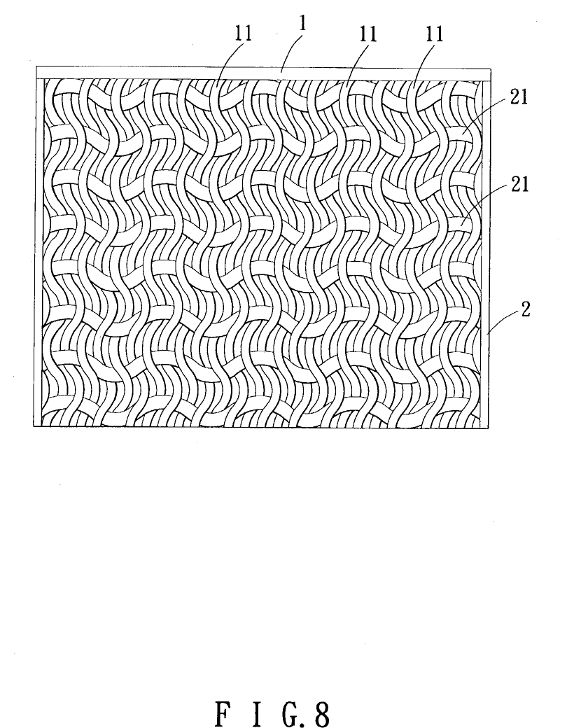

Referring to FIG. 8, the web-shaped structure formed by plastic material in accordance with the fourth embodiment of the present invention is similar to that in accordance with the first embodiment of the present invention, and the difference is described as follows. Each of the combination strips 11 of the first plastic member 1 is arranged in an arc-shaped and corrugated manner, and each of the combination strips 21 of the second plastic member 2 is arranged in an arc-shaped and corrugated manner, thereby enhancing the aesthetic quality of the product.

While the preferred embodiment(s) of the present invention has been shown and described, it will be apparent to those skilled in the art that various modifications may be made in the embodiment(s) without departing from the spirit of the present invention. Such modifications are all within the scope of the present invention.

What is claimed is:

1. A web-shaped structure formed by plastic material, comprising a first plastic member, and a second plastic member combined with the first plastic member integrally, wherein:
the first plastic member is provided with a plurality of combination strips; and
the second plastic member is provided with a plurality of combination strips, each of the combination strips of the second plastic member is mounted on the top end face of one of the combination strips of the first plastic member and is mounted on the bottom end face of the adjacent combination strip of the first plastic member, so that each of the combination strips of the second plastic member is combined with each of the combination strips of the first plastic member in a corrugated and intersecting manner, and the first plastic member and the second plastic member intersect each other and are combined integrally, thereby forming the web-shaped structure.

2. The web-shaped structure formed by plastic material in accordance with claim 1, wherein the combination strips of the first plastic member are arranged in a parallel manner and are spaced apart from each other.

3. The web-shaped structure formed by plastic material in accordance with claim 1, wherein the each of the combination strips of the first plastic member has a top end face and a bottom end face each formed with a plurality of recesses, each of the combination strips of the second plastic member includes a plurality of bent portions connected with each other, and each of the bent portions of the second plastic member is combined with a respective one of the recesses of the first plastic member.

4. The web-shaped structure formed by plastic material in accordance with claim 3, wherein the recesses on the top end face and the bottom end face of each of the combination strips of the first plastic member are arranged in a staggered manner.

5. The web-shaped structure formed by plastic material in accordance with claim 3, wherein the recesses on any two adjacent combination strips of the first plastic member are arranged in a staggered manner.

6. The web-shaped structure formed by plastic material in accordance with claim 3, wherein the bent portions on any two adjacent combination strips of the second plastic member are arranged in a staggered manner.

7. The web-shaped structure formed by plastic material in accordance with claim 3, wherein each of the bent portions 211 of the second plastic member 2 is integrally combined with a respective one of the recesses 12 of the first plastic member 1 by a plastic injection molding process.

8. The web-shaped structure formed by plastic material in accordance with claim 1, wherein the combination strips of the second plastic member are arranged in a parallel manner and are spaced apart from each other.

9. The web-shaped structure formed by plastic material in accordance with claim 1, wherein the recesses of the first plastic member and the bent portions of the second plastic member are formed with different patterns according to the practical requirements, so that the recesses of the first plastic member are combined with the bent portions of the second plastic member to form a predetermined figure pattern which protrudes outward from the first plastic member.

10. The web-shaped structure formed by plastic material in accordance with claim 1, wherein the first plastic member includes two opposite elongated rails each integrally formed on each end of each of the combination strips of the first plastic member, and the second plastic member includes two opposite elongated rails each integrally formed on each end of each of the combination strips of the second plastic member.

11. The web-shaped structure formed by plastic material in accordance with claim 1, wherein each of the combination strips of the first plastic member is arranged in an arc-shaped and corrugated manner, and each of the combination strips of the second plastic member is arranged in an arc-shaped and corrugated manner.
